(19) United States
(12) Patent Application Publication
(10) Pub. No.: US 2013/0298508 A1
(43) Pub. Date: Nov. 14, 2013

(54) JAR OPENER DEVICES AND METHODS

(71) Applicant: James J. Metcalf, Chesterland, OH (US)

(72) Inventor: James J. Metcalf, Chesterland, OH (US)

(21) Appl. No.: 13/470,266

(22) Filed: May 12, 2012

(51) Int. Cl. B67B 7/44; B65B 43/40; B67B 7/18

(52) U.S. Cl. 53/492; 81/3.43; 81/3.09

(57) ABSTRACT

A handheld jar opener device has a handle and a strap extending from near a corner of the front and one (left) side of the handle. The strap is formed into a loop in front of the handle, and extends through a tunnel disposed diagonally through the handle from near a corner of the front and an opposite (right) side of the handle to the one (left) side of the handle, with a residual portion of the strap extending beyond the handle. The device may engage the lid of a jar, or the body of the jar. Two devices may be used as a system to engage both the lid and body of the jar. Force applied to the handle(s) is translated as torque to the lid and/or body of the jar.

### TECHNICAL FIELD

The invention relates generally to devices commonly referred to as “jar openers” and, more particularly, to a device having a handle and a strap which can be wrapped around the lid of a jar, engaging the lid, so that force (torque) applied by a user to the handle of the device may be transferred to the lid, such as for unscrewing the lid from the mouth of the jar. Typically, the user holds the device in one hand, and stabilizes the jar during the opening procedure with his (her) other hand grasping the body of the jar.

### BACKGROUND

A jar opener is a device which may be used for assisting a user in removing a lid from a jar, or other container (such as a bottle or a can) which has a screw on lid (or cap). Typically, the lid is screwed tightly onto the top (or mouth) of the jar to seal contents (such as, but not limited to foodstuff) in the jar, and must be removed from the jar to access the contents. The lid has an internal thread, the mouth of the jar has an external thread. Typically, the lid screws clockwise onto (relative to) the jar to install the lid onto the jar, and it may be firmly seated on the mouth of the jar. The lid is turned (rotated) counter-clockwise to remove the lid from the jar.

Sometimes, when the lid has been well seated, a significant torsional force (torque) needs to be applied to the lid, typically while maintaining the jar itself stationary, to initiate removing the lid. The force on the lid is applied in one direction (such as clockwise, the restraining force on the jar is applied in the opposite, counter-clockwise direction. (The jar may, of course, be turned in the opposite direction, rather than merely restrained.)

A jar opener device may be employed to assist the user in unseating the lid. Thereafter, the lid can usually be further rotated by hand (without the aid of the jar opener), but in some cases the user may elect to use the jar opener for more than the initial unseating of the lid. A jar opener can also be used to screw the lid back onto the jar and seat if firmly on the mouth of the jar, but primarily the difficulty arises when trying to unscrew the lid from a jar that has previously been closed, particularly for some period of time. A jar opener may be particularly useful for large jars, such as jars having lids up to approximately 8 inches in diameter. An 8 inch lid has twice the circumference of a 4 inch lid, and much more surface are for contact and stiction between the lid of the jar and the threaded opening (mouth, including lip) of the jar.

There have been numerous patents granted for jar openers, among which are the following US patents, incorporated by reference herein. U.S. Pat. No. 6,948,404 discloses a handle and strap are used to engage a cap of a jar using a Velcro closure to hold the strap in place. U.S. Pat. No. 4,532,831 discloses a jar opener comprising a cord looped around the cap with a handle. The cord is twisted which applies pressure to the cap and thereafter removes the cap of the jar. U.S. Pat. No. 4,306,470 discloses an elongated handle with a semicircular jaw at one end and a second jaw on the other end. When closed around the cap the jaws provide enough pressure so as to open a jar. U.S. Pat. No. D440,842 discloses two adjustable jaws which grip the cap on two opposite sides. A handle is provided so as to grasp and twist the cap thereby removing the cap of a jar.

Some disadvantages or limitations of prior art jar openers may include (i) ease of use and (ii) how force is translated from the jar opener device to the lid. In the case of a container which is a metal can (or, an oil filter, for example), forces applied via the jar opener device radially to the container can crush or break the container. The most useful force which can be applied by the jar opener to the lid is tangential, in the direction of the desired rotation for the lid.

### SUMMARY

It is an overall object of the invention to provide improved “jar opener” apparatus (or jar opener, jar opener/opening device) and method(s) of use which has at least some of the advantages of the prior art, while avoiding at least some of the disadvantages inherent therein.

According to the invention, generally, a handheld “jar opener” device comprises a handle and a strap extending from the handle. The strap may wrap around and engage an object such as a jar lid to facilitate a user exerting a significant torsional force on the jar lid for turning the lid, to unseat (or seat) the lid. The strap is adjustable in length to facilitate griping various size (diameter) lids, and may have a non-slip surface to ensure a good grip on the lid. The user may stabilize the jar with his (her) other hand, by gripping the body of the jar. The user may rotate the jar in a direction opposite from the direction of rotation of the lid, to unseat (or seat) the lid.

As a general proposition, the diameter of a jar lid is approximately equal to the diameter of the jar body. Hence, for example, the same jar opener device may be used to grip either the lid or body of a given jar. For example, a handheld “jar opener” device comprising a handle and a strap extending from the handle can be used to grip (engage) the body of the jar, for turning or stabilizing the jar, while the user restrains or turns the lid with his (her) other hand, respectively, for unseating or seating the lid.

Prior art jar openers generally require trying to hold the jar while using the jar opener to twist the lid. That can be very difficult, especially for those with weaker hands. According to an embodiment of the invention, two jar opener devices, each comprising a handle and a strap, may be used, in combination with one another, one for gripping (engaging) the lid and one for gripping (engaging) the body of the jar. In this technique (or application), the lid may be turned while restraining the jar, to unseat (or seat) the lid. Or, the jar may be turned while restraining the lid, to unseat or seat the lid. Or, the jar and the lid can both be turned in opposite directions to unseat or seat the lid. The two jar opener devices may be substantially the same as one another, but may be mounted to (engaged with) the lid and the jar in opposite orientations.

Typically, in the two opener technique, the first jar opener device is releasably mounted to the jar body before positioning the second jar opener on the lid. An advantage of the jar opener device disclosed herein is that the jar opener device which is positioned on the jar body is capable of holding itself in place while the user positions the other jar opener device on the lid of the jar.

According to an exemplary non-limiting embodiment of the invention, the jar opener device may comprise a 4 to 5 inch long handle with an 18 to 30 inch strap attached thereto and extending therefrom. A tunnel having an entry opening on one side of the handle and an exit opening on the other side of the handle, and extending diagonally through the handle, allows the for the strap to pass through the handle which allows the user to easily slide the strap into position on the lid or jar body, adjust the strap to grip the jar, and the tunnel provides enough friction to prevent the strap from slipping so that the jar opener device can stay positioned on the jar body. The position of the strap on the handle allows for easy positioning of the opener on a lid without significant alignment issues. (Engaging the strap on the body of a jar is much less alignment sensitive.) Some exemplary dimensions for the jar opener device may be:
a gripping handle of 4 to 5 inches in length with a concave channel formed on one side of an end of the handle and an angled tunnel originating on the opposite side of the end of the handle and terminating on the other side of the handle approximately 1½ inches from the end of the handle;
A plastic non-stretch strap of 18 to 30 inches with a tensile strength of 50 to 150 pounds and a loop at one end of the strap, and optionally including a rubberized coating on the “inner” side of the strap which will contact and engage the lid or body of the jar;
A pivot post of ¾ to 1 inch in length which passes through the loop on the terminal end of the strap and thereby attaches the strap to the handle.

The user has the option of using one jar opener on the lid by itself or using a second jar opener additionally positioned on the jar body. For the single jar opener application, the user positions the strap on the lid then grasps the handle of the jar opener device with one hand and uses their other hand to stabilize (or counter-rotate) the jar. The user pulls or pushes the handle of the jar opener device in a counter-clockwise direction thereby loosening the lid while rotating the lid of the jar to the open position.

For the two (dual, double) jar opener application, the user positions one jar opener device on the jar body, and positions the other jar opener device on the lid (as in the one opener application). The user pulls the handle that is positioned on the lid in a counter-clockwise direction while pushing or pulling the handle positioned on the jar in the opposite, clockwise direction. This two jar opener application greatly reduces the strength required by the user to stabilize (including turning) the jar and increases the amount of torsional force (torque) that can be applied by a person—for at least two reasons:
1. The jar opener devices securely grip the jar/lid without requiring any hand strength. Since the user doesn't have to worry about gripping anything, he/she can devote full strength to applying torque (using the larger arm muscles).
2. The device handle significantly extends the “lever arm length” for the application of torque, effectively multiplying the torsional force that results from the same amount of tangential force applied by the user. Additionally, it is generally much easier to push, or even to pull, than it is to twist a hand held object.

It should be noted, in the two jar opener application, the jar and lid will typically have approximately the same diameter, and two substantially identical jar opener devices can be used, one for gripping (engaging) the lid, the other for engaging the jar body. In some cases, or as is typically the case with beverage bottles (versus jars), the lid (or cap) may have a noticeably smaller diameter than the body of the jar. Inasmuch as the strap is adjustable, nevertheless two substantially identical jar openers can be used, as before—one for gripping (engaging) the lid (or cap), the other for engaging the jar (or bottle) body. In some cases, it may be advantageous to provide two different jar opener devices—one which is perhaps smaller and better suited for gripping the lid (or cap), the other of which is larger and better suited for gripping the jar (or bottle) body.

Jar opener devices may be supplied in sets of two substantially identical devices. Alternatively, two or more jar opener devices may be provided, with different ranges of adjustment/applicability, such as one device for medium to large size jars, the other for small to medium size lids. In some embodiments, the strap may be removable and replaceable, in which case additional straps may be provided to extend the usefulness of the jar opener device.

The jar opener(s) is (are) designed for easy use by anyone needing increased torsional force to disengage the lid of a jar. These benefits may be doubled in the two jar opener application.

It is within the scope of the invention that the jar opener device(s) may be used to apply torsional force to items other than jars and bottles. For example, the jar opener device may be used to grip and rotate a typical cylindrical automotive type oil filter. Such a device may have a special gripping surface on the strap to engage the metal body of the oil filter.

Other objects, features and advantages of the invention will become apparent in light of the following description(s) thereof.

### BRIEF DESCRIPTION OF THE DRAWINGS

Reference will be made in detail to various embodiments of the invention, examples of which may be illustrated in the accompanying drawing figures. The figures are intended to be illustrative, not limiting. Although the invention may be generally described in the context of these preferred embodiments, it should be understood that it is not intended to limit the spirit and scope of the invention to these particular embodiments.

Certain elements in selected ones of the drawings may be illustrated not-to-scale, for illustrative clarity. The cross-sectional views, if any, presented herein may be in the form of “slices”, or “near-sighted” cross-sectional views, omitting certain background lines which would otherwise be visible in a true cross-sectional view, for illustrative clarity.

Elements of the figures may be numbered such that similar (including identical) elements may be referred to with similar numbers in a single drawing. For example, each of a plurality of elements collectively referred to as 199 may be referred to individually as 199a, 199b, 199c, etc. Or, related but modified elements may have the same number but are distinguished by primes. For example, 109, 109′, and 109″ are three different versions of an element 109 which are similar or related in some way but are separately referenced for the purpose of describing modifications to the parent element (109). Such relationships, if any, between similar elements in the same or different figures will become apparent throughout the specification, including, if applicable, in the claims and abstract.

The structure, operation, and advantages of some embodiments embodiment of the invention(s) will become further apparent upon consideration of the following description taken in conjunction with the accompanying drawings, wherein:

FIGS. 1A, 1B, 1C and 1D are top, left, right and bottom plan views, respectively, of a “basic” jar opener device, simplified (and stylized) for describing a number of elements and features of various embodiments and implementations of the invention.

FIG. 1E is a perspective view of a strap component for the jar opener device of the invention.

FIG. 1F is a perspective view, partially cutaway, of a jar opener device, according to an embodiment of the invention.

FIG. 1G is a partial perspective view of a portion of a jar opener device, according to an embodiment of the invention.

FIG. 1H is a partial perspective view of a portion of a jar opener device, according to an embodiment of the invention.

FIG. 1I is a partial top plan view, partially cutaway, of a jar opener device, according to an embodiment of the invention.

FIG. 2A is a perspective view of a jar opener device, according to an embodiment of the invention.

FIG. 2B is a schematic plan view of a jar opener device with hidden elements illustrated by ghosted lines, according to an embodiment of the invention.

FIG. 3 is a perspective view showing a jar opener device gripping the lid for a jar, according to an embodiment of the invention.

FIG. 3A is a sequence diagram showing steps for a method of using a jar opener device, according to an embodiment of the invention.

FIG. 4 is a perspective view showing one jar opener device gripping the lid for a jar, and another jar opener device gripping the body of the jar, according to an embodiment of the invention.

FIG. 4A is a sequence diagram showing steps for a method of using two jar opener devices, according to an embodiment of the invention.

### DETAILED DESCRIPTION

The invention relates generally to handheld “jar opener” devices for assisting a user in removing (or applying) lids (generally screwed-on) from containers such as jars, such as standard jars containing foodstuff, mason jars and the like. Generally, the jar opener device(s) enable the user to, with one hand, apply more force (torque), or to apply force more easily and effectively, to the lid of the jar while either (i) holding the jar stationary with his (her) other hand (requiring the application of force in the opposite direction), or (ii) using a second handheld jar opener device to apply more easily an opposite force to the jar (including simply holding the jar stationary while turning the lid). The jar opener device itself is designed to be used on either the lid or the jar, and in general, identical jar opener devices may be used for applying a rotational force to the lid and/or the jar body.

The device(s) disclosed herein may be useful for removing (or installing) lids, caps, and the like from containers other than jars, such as cans or bottles. A difference between a jar (or can) and a bottle is generally that whereas the lid for a jar typically has approximately the same diameter as the body of the jar, a bottle has a neck and the lid (or cap, etc) typically has a diameter significantly less than the diameter of the body of the bottle. However, jars may also have a neck with a lid such that both are smaller in diameter than the body of the jar, therefor terms used herein for a container (e.g., jar) and its removable closure (e.g., lid) are not to be considered limiting of scope since the terms are applied loosely according to common usage and understanding. In the main hereinafter, handheld devices will be described for assisting a user in removing screw-on lids from jars, but this description should be considered representative of the device's usage on any related container with a lid/cap that may be removed or applied by turning it relative to the body of the container.

Various embodiments may be described to illustrate teachings of the invention(s), and should be construed as illustrative rather than limiting. An embodiment may be an example or implementation of one or more aspects of the invention(s). Although various features of the invention(s) may be described in the context of a single embodiment, the features may also be provided separately or in any suitable combination. Conversely, although the invention(s) may be described herein in the context of separate embodiments for clarity, the invention(s) may also be implemented in a single embodiment.

The relationship(s) between different elements in the figures may be referred to by how they appear and are placed in the drawings, such as “top”, “bottom”, “left”, “right”, “front”, “back”, and the like. It should be understood that the phraseology and terminology employed herein is not to be construed as limiting, and is for descriptive purposes only.

### Some Embodiments of Jar Opener Devices

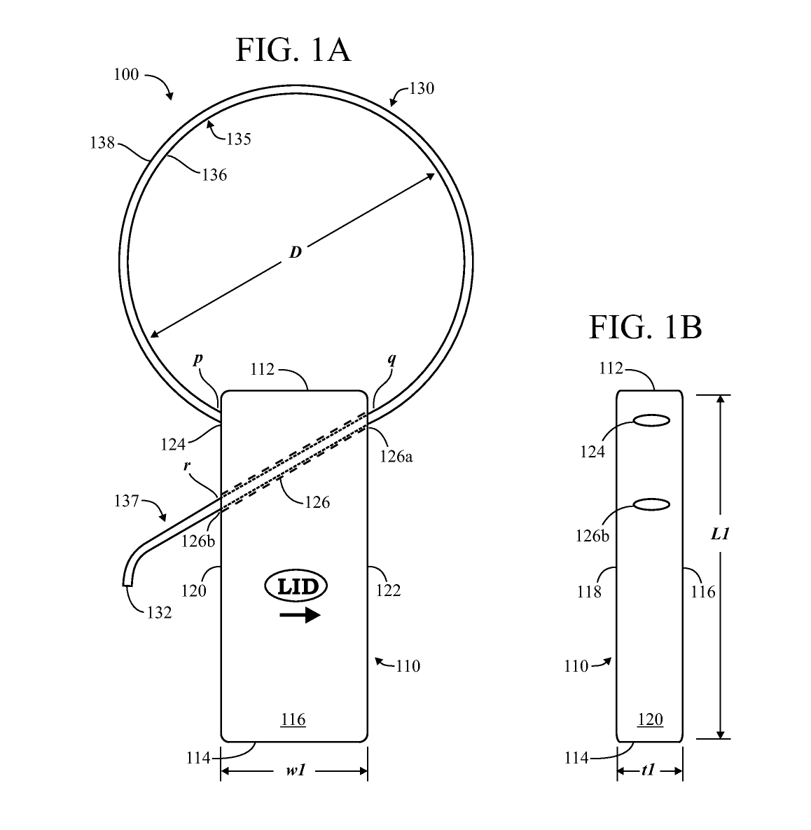

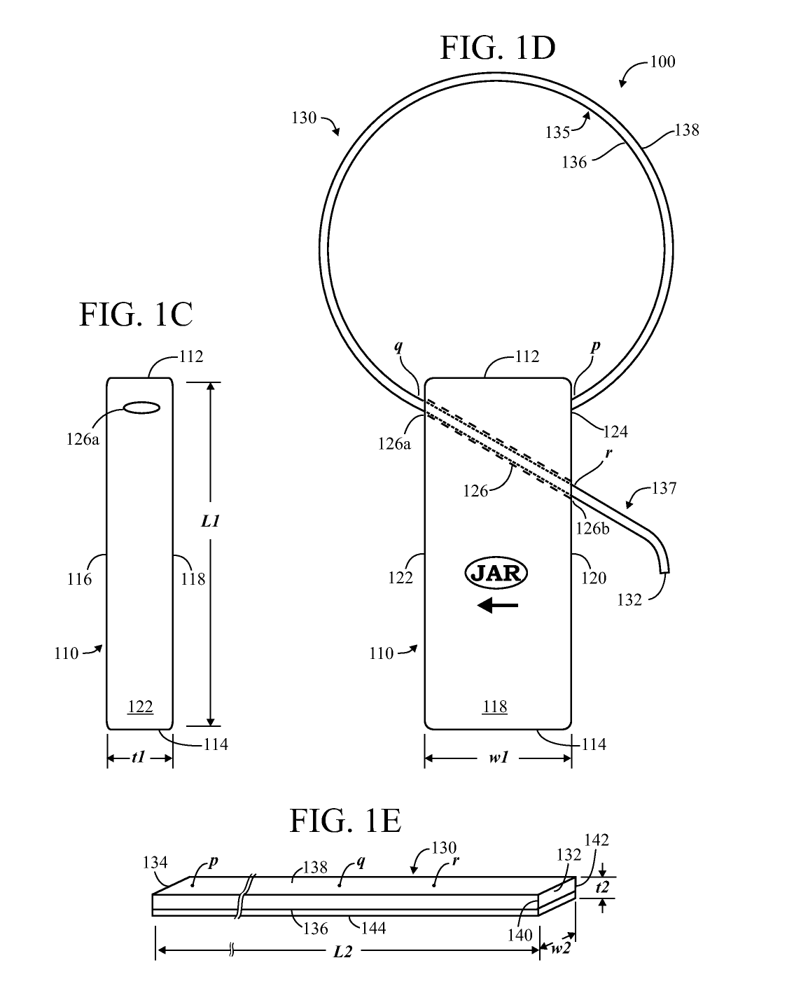

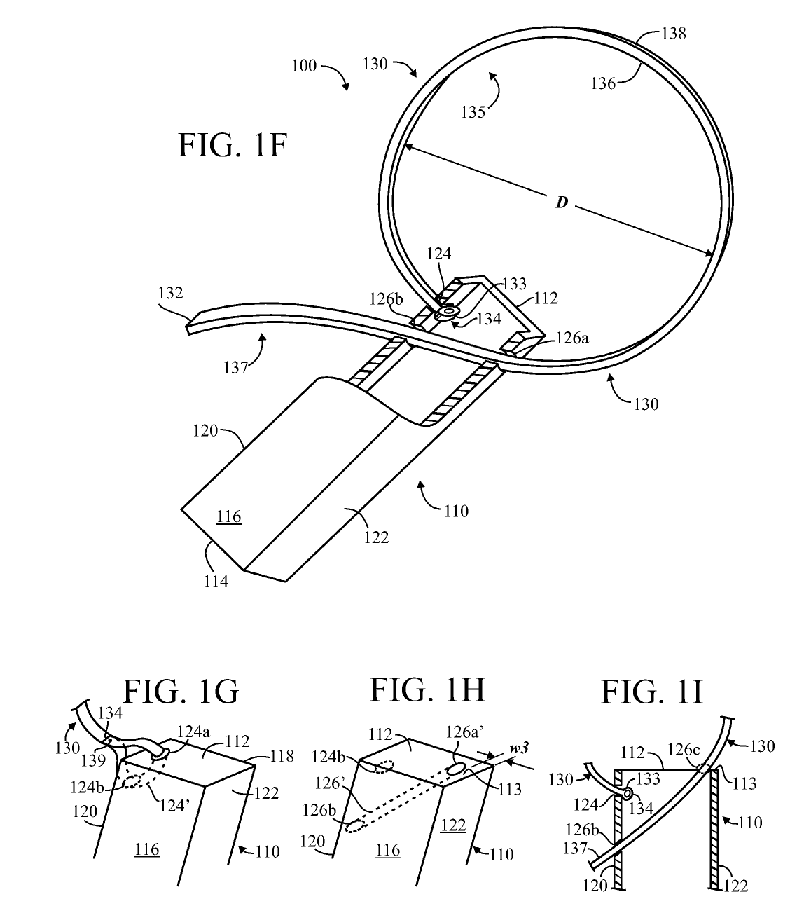

FIGS. 1A, 1B, 1C and 1D are top, left, right and bottom plan views, respectively, of a “basic” jar opener device 100, simplified (and stylized) for describing a number of elements and features of the invention. The jar opener device 100 comprises two major components: a handle 110 and a strap 130. The strap 130 is omitted from the views of FIGS. 1B and 1C, for illustrative clarity. FIG. 1E is a detailed view of the strap 130. FIGS. 1F, 1G and 1H show alternate constructions.

The handle (or grip) 110 is shown as a solid elongated member, and may be formed of a rigid material such as hard plastic, or bakelite. The handle 110 is shown having a rectangular cross-section, but may have a round or oval cross-section, and may have some rounded edges and contoured surfaces so as to be more ergonomic and easy to grip. The handle 110 may be in the form of a knife handle, or pistol grip. The handle 110 may be formed by injection molding.

The handle 110 may have the following ends, surfaces and sides:
a front end 112 (proximal to a loop 135 of the strap 130), and a back end 114 (distal to the loop 135), and a length “L1” (as measured between the front and back ends) of approximately 4-5 inches.
   A longitudinal axis for the handle 110 may be defined as a line extending between the opposed front and back ends 112 and 114, in the center of the handle 110.
   The front end 112 may comprise a substantially flat surface which is generally perpendicular to the longitudinal axis of the handle 100.
two opposite top and bottom surfaces 116 and 118 respectively, and a thickness “t1” (as measured between the top and bottom surfaces) of approximately ¾-1½ inches.
two opposite left and right sides (or side surfaces) 120 and 122, respectively, and a width “w1” (as measured between the left and right sides) of approximately 2-3 inches.

The aforementioned cross-sectional shape and dimensions are intended to be illustrative, not limiting, and in the case of a handle having a circular cross-section, the handle would be cylindrical and the thickness “t1” and width “w1” would both correspond to the diameter of the cylinder. As will be discussed below, a somewhat rectangular handle having contours on one side thereof for the user's fingers provides a useful “finger grip” feature and some advantages (e.g., ergonomic) over handles having other shapes.

An opening (or slot) 124 may be provided on the left side 120 of the handle 110, such as approximately ⅜ inches from the front end 112 of the handle 110. A tunnel 126 may extend diagonally through the handle 110 from an entrance (entry) opening 126a at the right side 122 of the handle 110, such as approximately ⅜ inches from the front end 112 of the handle 110, to an exit opening 126b at the left side 120 of the handle 110, such as approximately 1½ inches from the front end 112 of the handle 110. In other words, the slot 124 is disposed on one (the left) side 120 of the handle 110, the entrance opening 126a of the tunnel 126 is on the opposite (right) side 122 of the handle 110, and the exit opening 126b of the tunnel 126 is on the same side 120 of the handle 110 as the slot 124 but is longitudinally displaced therefrom, towards the back end 114 of the handle 110. Further details of the construction of the handle 110, the slot 124, the tunnel 126, and how the strap 130 attaches to and interacts with the handle 110 will be described hereinbelow.

The strap 130 is an elongated member and may be formed of a flexible, semi-rigid material such as nylon. (The strap 130 should be substantially non-elastic, but flexible and easily formed into loops having various diameters, and should be able to retain its loop shape in a self-supporting manner.) The strap 130 is shown by itself in FIG. 1E, and may have a rectangular cross-section, including the following ends, edges and surfaces . . . .
a free end (or “tip”) 132 and an opposite end 134, and length “L2” (as measured between the free and opposite ends) of approximately 20-30 inches. The opposite end 134 may be fixed (attached to) to the handle 110, as described in greater detail hereinbelow, and may be referred to as the “anchored” end 134.
an inner surface 136 and an outer surface 138, and a thickness “t2” (as measured between the inner and outer surfaces) of approximately 1/16-⅛ inches.
two opposite edge surfaces 140 and 142, and a width “w2” (as measured between the two opposite edge surfaces) of approximately ¼-⅜ inches.

In use, the strap 130 will encircle the lid (or body) of a jar, and its length “L2” and width “w2” may be selected to accommodate any size lid (or body) up to (for example) 8 inches in diameter. (The thickness “t2” of the strap 130 is generally not critical to the operation of the jar opener, other than as it provides tensile strength.) The strap 130 may have a tensile (breaking) strength of 50 to 150 pounds. The strap 130 may comprise or be similar to a conventional cable tie, also known as a zip tie or tie-wrap, which is a type of fastener typically used for binding several electronic cables or wires together.

As illustrated in FIG. 1F, the handle 110 may be hollow, and the strap 130 may in fact be a conventional cable tie having an enlarged portion 133 (which may be referred to as a “ratchet clasp”) at its end 134 which is disposed within the handle 110 with the strap extending out of the slot 124 which may be a hole slightly larger than w2 and t2.

In the case of solid handle 110, the tunnel 126 may be an “actual” tunnel having walls along its entire length between its entry and exit openings 126a and 126b. In the case of a hollow handle 110, the tunnel 126 may be a “virtual” tunnel defined by the substantially straight-line path between the entry opening 126a and the exit opening 126b. In either case, the tunnel 126 is sized and shaped to correspond generally with the cross-section and dimensions of the strap 130 so that the strap 130 may engage (fit snugly, but movably within) the tunnel 126 (and/or its openings 126a and 126b) with a small, yet sufficient amount of friction so that when the free end 132 of the strap is pulled to cinch the jar opener tool 100, 200 around the lid (or body) of a jar, there is sufficient friction to keep the strap 130 from slipping back out of the tunnel 126 and thereby to keep the jar opener device releasably mounted to the lid (or body) of the jar. This “self supporting” (staying in place without further assistance from the user) feature is not evident in comparable devices of the prior art.

The inner surface 136 of the strap 130 may be provided with frictional properties for improving the grabbing of a lid (or body) of a jar, such as by providing a cross-hatch pattern, ridges, or the like) on the inner surface 136 of the strap 130. Conveniently a conventional tie wrap has a ridged “gear rack” surface on at least one side for engaging the ratchet clasp 133. Alternatively (or additionally), as shown in FIG. 1E, a layer or coating 144 of a rubber-like material may be provided (disposed) on the inner surface 136 of the strap 130. In other words, the inner surface 136 of the strap 130 may advantageously be a non-slip surface for securely gripping the lid or body of a jar. In another embodiment the ridged gear rack-like inner surface is given the coating 144 so that the rubber-like inner surface has a ridged pattern which enhances its gripping power. More generally, the jar opener device 100 is sized and shaped, and adapted in use to securely and releasably engage either the lid or the body of a container.

In FIGS. 1A-1F, the strap 130 is shown emerging from one (left) side 120 of the handle 110 at a point “p” along its length (substantially at the end 134) and re-entering the handle 110 on the opposite (right) side 122 of the handle 110 at a point “q” along its length (at some position between the two ends 132 and 134). A loop portion 135 of the strap 130 is defined as that portion of the strap between the points “p” and “q”. The position of the point “q” will depend on how the strap 130 is adjusted. This loop portion 135 of the strap 130 will naturally assume a substantially circular shape, and will constitute the primary interface for transferring force (torque) between the jar opener device 100 and the lid (or jar). The distance between the points “p” and “q” will correspond to the circumference of a lid (or jar body) being gripped (engaged) by the strap 130 when it is cinched securely around the lid or jar body, such as for unseating (and unscrewing) the lid from the jar.

The strap 130 emerges from the tunnel 126 on the left side 120 of the handle at a point “r” along its length (at some position between the point “q” and the free end 132), and the portion of the strap 130 between the point “r” and the free end 132 may be referred to as the “residual” portion 137 of the strap 130. The end 132 itself may be deformed, or an element added thereto, so that it cannot pass back through the tunnel 126.

In a typical use scenario, the loop portion 135 may be 12-24 inches long, having a diameter “D” of approximately 4-8 inches, a portion of the strap 130 (between the points “q” and “r”) within the tunnel 126 may be 2-4 inches long, and the length of the residual portion 137 of the strap 130 may be approximately 6-18 inches.

As mentioned above, the jar opener device 100 is suitable for grasping (engaging) either the lid for or the body of a jar. And, two similar (or identical) jar opener devices such as the device 100 can be used to grasp both the lid and the jar, in which case the devices would be used in different orientations, as described in greater detail hereinbelow. To this end, the top surface 116 of the handle 110 may be labeled with a legend, indicia or symbol such as “LID” (FIG. 1A), and the bottom surface 118 of the handle 110 may be labeled with an indicia or symbol such as “JAR” (FIG. 1D). These indicia may be accompanied by a directional arrow. As best viewed in FIG. 1A, an arrow symbol pointing to the right on the top surface 116 indicates the direction of rotation to unseat the lid. As best viewed in FIG. 1D, an arrow symbol pointing to the left on the bottom surface 118 indicates the direction of rotation (or applied force) on the jar which will unseat the lid. (In use, when applied to the body of a jar for unseating the lid, the bottom surface 118 of the second jar opener device would be oriented up as shown in FIG. 1D.)

FIGS. 1G and 1H illustrate some alternate constructions for a jar opener device. Most of the elements are identical to those of the jar opener device 100 (FIGS. 1A-1F), so only those that are different will be discussed in some detail.

FIG. 1G illustrates that the slot 124′ (compare 124) may be disposed at or near a corner of the left side 120 and the front end 112 of the handle, with an entry opening 124a on one (left, as viewed) side of the front end 112 of the handle 110, and an exit opening 124b on the left side 120 of the handle 110. An end portion, including the end 134 of the strap 130 may extend through this slot 124′ and be doubled back on and secured to itself, such as with a fastener 139, such as a rivet, or simply with an adhesive. (Or, in the case of a strap 130 which is a conventional cable tie, the fastener 139 can be the ratchet clasp 133 at the end 134 and the strap 130 passes therethrough after being extended through the slot 124′.)

FIG. 1H illustrates that the entry opening 126a′ (compare 126a) for the tunnel 126′ (compare 126) may be disposed on the front end 112 of the handle 110, near the right side 122. The exit opening 126b is still located on the left side 120 of the handle, longitudinally displaced from the exit opening for the strap 124b towards the back end (114, not shown) of the handle 110.

The entry opening 126a′ may be spaced a distance “w3” such as ⅛-½ inch from the right side 122 of the handle 110, and a portion of the front end 112 of the handle 110 between the entry opening 126a′ and the right side 122 of the handle 110 constitutes a “lever surface” 113 of the handle 110, the purpose of which is to apply leverage on the outer surface 138 of the strap 130 when the strap 130 is in the process of being engaged with a lid (or body) of a jar. In other words, when torque is applied to the handle 110 in the direction from the left side 120 to the right side 122 of the handle 110, the handle 110 will tend to pivot to the right with the lever surface 113 being its fulcrum, resulting in radial force crushing the strap 130 against the lid where it is pinched by the lever surface 113. Since this firmly fixes the right end of the strap loop 135, the handle will be attempting to stretch the strap 130 by pulling its attached end 134 away from the lid. Since the strap 130 is substantially inextensible, the pulling becomes a tangential force applied to torquing the lid while simultaneously constricting the strap loop 135, thereby increasing the frictional grip on the lid.

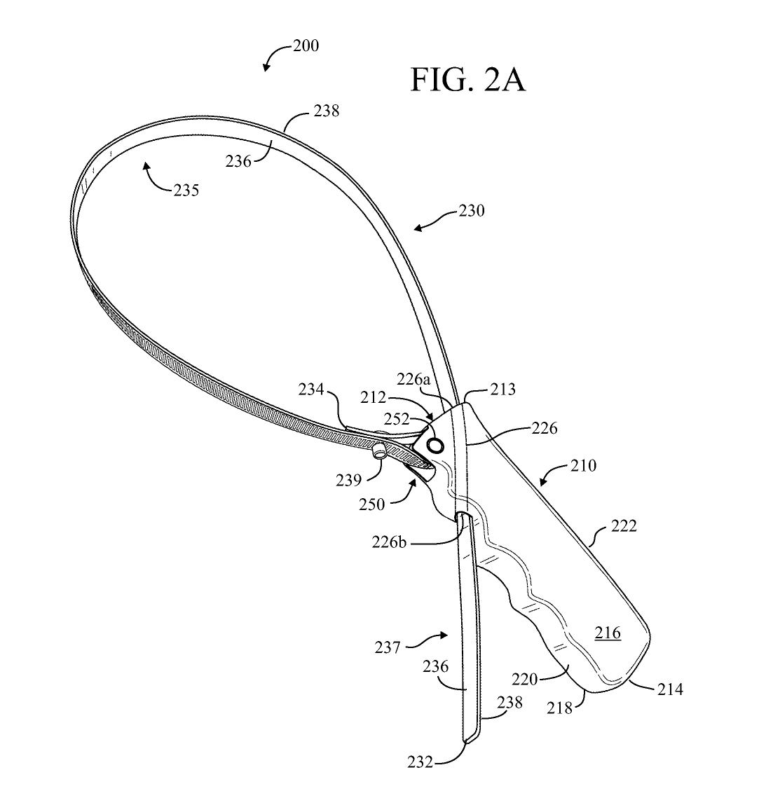

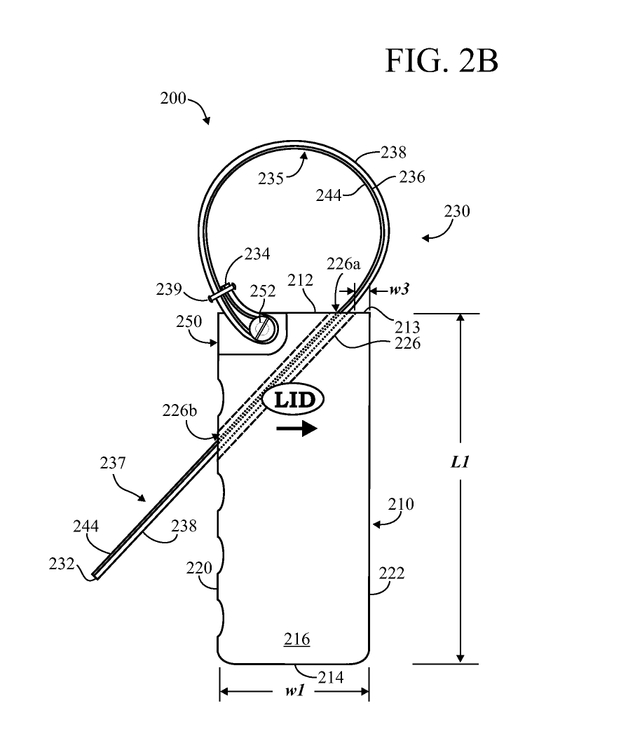

The lever surface 113 may be a portion of the front end 112 of the handle 110, and may extend a distance “w3” of approximately 1/16-½ inch, such as ⅛-¼ inch from the right side 122 of the handle 110, towards the left side 120 of the handle 110 (generally, to the entry opening 126a). The distance “w3” may be a small fraction of the width “w1”. The lever surface 113 on the front end 112 of the handle 110 is disposed to engage the outer surface (138) of the strap (130) where it enters the tunnel 126′. (See also the lever surface 213, tunnel 226 and entry opening 226a in FIGS. 2A-2B.)

Recall that in the embodiment described with respect to FIGS. 1A-1F, the slot 124 is disposed on one (the left) side 120 of the handle 110, the entry opening 126a of the tunnel 126 is on the opposite (right) side 122 of the handle 110. As best viewed in FIG. 1B, the exit opening 126b for the tunnel (126) is disposed on the same side 120 of the handle 110 as the slot 124, but is longitudinally displaced therefrom, towards the back end 114 of the handle 110. In the embodiments shown in FIGS. 1G and 1H, the entry opening 124a for the slot 124′ is located at a position on one (left, as viewed) side of the front end 112 of the handle 110, and the entry opening 126a′ for the tunnel 126′ is located at a position on an opposite (right, as viewed) side of the front end 112 of the handle 110. The exit opening 126b of the tunnel 126′ is on the same side 120 of the handle 110 as the exit opening 124b for the slot 124′, but is longitudinally displaced therefrom, towards the back end (114) of the handle 110.

The slot 124 (FIG. 1A) or exit opening 124b (FIG. 1G) for the slot 124′ may be provided on the left side 120 of the handle 110, such as approximately ⅜ inches from the front end 112 of the handle 110. The tunnel 126 (FIG. 1A) or 126′ (FIG. 1H) may extend diagonally through the handle 110 from an entry opening 126a (FIG. 1A) at the right side 122 of the handle 110, such as approximately ⅜ inches from the front end 112 of the handle 110, or from an entry opening 126a′ (FIG. 1H) on the right side of the front end 112 of the handle 110, to the exit opening 126b at the left side 120 of the handle 110, such as approximately 2-4 inches from the front end 112 of the handle 110. In other words, the exit opening 126b for the tunnel 126 or 126′ is disposed longitudinally towards the back end (114) of the handle 110 away from the slot 124 or exit opening 124b for the slot 124′ by approximately 1-3 inches. Alternatively one may say that the tunnel exit opening 126b is located “behind” the slot 124, 124′.

FIG. 1I shows a portion of another embodiment of a jar opener device having a handle 110 which may be round (cylindrical), such as a 1 inch diameter plastic pipe having a front end 112, a left sidewall 120, a right sidewall 122 (which is the same sidewall continued to the other side), an opening 124 in the left sidewall 120 near the front end 112, a strap 130 having an end 134 with a portion of enlarged diameter 133 extending from within the handle 110 through the opening 124, looping around (having a loop portion 135 for engaging a lid or body of a jar) and re-entering the handle 110 at the front end, all in a manner very similar to the embodiment of FIG. 1H.

In this embodiment, there is no distinct entry opening (contrast 126a, 126a′) in the front end 112 of the handle 110 for the strap 130. Rather, the strap 130 enters the wide opening at the front end 112 of the cylindrical pipe-like handle 110, and due to its inherent stiffness, positions itself from a position 126c shown as a dashed line oval (compare 126a′) which is against the inner surface of the right sidewall 122 at the front end 112 of the handle 110, extends diagonally across the handle 110 to the left sidewall 120, and exits the handle 110 through an exit opening 126b which is located behind (towards the back end, not shown) the opening 124 and the attached end 134 of the strap 130. A “virtual” tunnel is defined by the substantially straight-line path between the entry opening 126c and the exit opening 126b. The residual portion 137 of the strap is illustrated.

This embodiment highlights the lever surface feature 113 which is a portion of the handle 110 on the front end 112 of the handle, to the right (as viewed) of the opening 126c (compare 126a′), i.e., on the front end 112, between the tunnel entrance 126c and the right side 122 of the handle 110. The width dimension (“w3”) of the lever surface 113 is small, and when the handle 110 is cocked (by applying torsional force) to engage a lid (or body) of a jar (as described hereinbelow), the lever surface 113 engages the outer surface (138) of the strap 130 without imposing a significant radially inward force on the lid (or body) of the jar (or container), as mentioned above. Here, the width dimension (“w3”) of the lever surface 113 is the thickness of the sidewall 122, such as 3/32 inch.

FIG. 2A shows an embodiment of an implementation of a jar opener device 200 (compare 100), having a handle 210 (compare 110) and a strap 230 (compare 130). FIG. 2B is a schematic plan view of the jar opener device 200 with hidden elements illustrated by ghosted lines. Many of the elements of the jar opener device 200 may be the same as described with respect to the jar opener device 100, and similar elements may be similarly numbered, but starting with “2” rather than “1” (in the hundreds' place).

The handle 210 has a front end 212 (compare 112), a back end 214 (compare 114), a top surface 216 (compare 116), a bottom surface 218 (compare 118), a left side 220 (compare 120), and a right side 222 (compare 122). The handle 210 has a lever surface 213 (compare 113) which has a width w3.

A strap 230 (compare 130), having an inner surface 236 (compare 136) and an outer surface 238 (compare 138), extends from an anchored end 234 (compare 134) which is attached to the handle 210 at or near a corner of the left side 220 and the front end 212 of the handle 210, forms a loop 235 (compare 135), and extends through a tunnel 226 (compare 126) which passes diagonally through the handle 210 from an entry opening 226a (compare 126a′, 126c) near the right (as viewed) side of the front end 112 of the handle 210 to an exit opening 226b (compare 126b) on the left side 220 of the handle 210. A residual portion 237 (compare 137) of the strap 230 extends beyond the handle 210, terminating in a free end 232 (compare 132). The left side 220 of the handle 210 may be contoured, or formed with an “undulating” pattern forming a few (2-4) grooves or valleys for conforming to and comfortably receiving the fingers (3 or 4) of a user grasping the handle 210. The remaining sides and surfaces of the handle 210 may be substantially flat, or slightly rounded, and provided with a non-slip (or matte) finish.

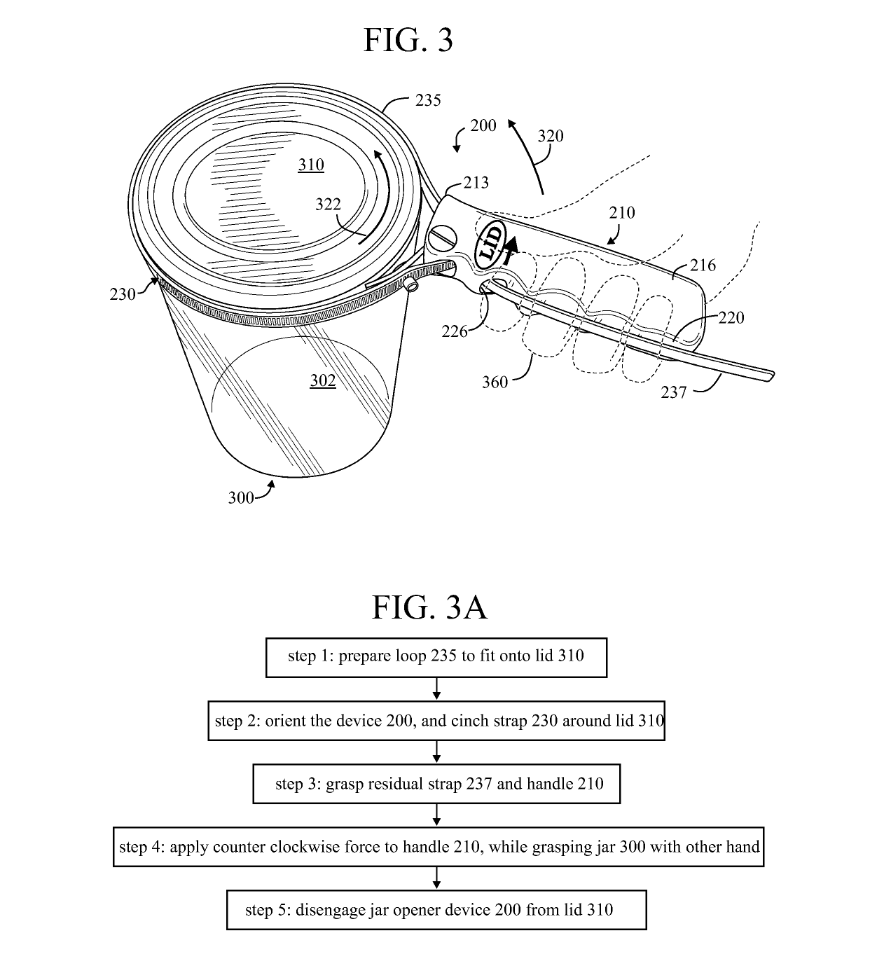

The residual portion 237 of the strap 230, extending out of the exit opening 226b of the tunnel 226, is sufficiently long that it can be secured against the handle 210 when the handle is gripped by a user (See FIG. 3).

The opposite/anchored end 234 (compare 134) of the strap 230 may be attached (fixed) in any suitable manner to the handle 210, preferably at or near the front end 212 of the handle 210. For example, as best viewed in FIGS. 2A and 2B, a slot (channel, cutout, recess) 250 may be provided near the corner of the left side 220 and the front end 212 of the handle 210. The slot 250 may be an opening of approximately ⅜ inches (large enough to receive the anchored end portion of the strap) extending/curving (approximately 90 degrees) from the left side 220 to the front end 212 of the handle 210.

A post or screw 252 may be provided in the area of the slot 250, and an end portion 234 (compare 134) of the strap 230 wraps around the post 252, back onto itself, and can be secured to itself with a faster 239 (compare 139), adhesive or the like. The post 252 may have a ⅛ inch diameter.

The strap 230 forms a loop 235 (compare 135), its free end 232 passes through the tunnel 226 and a residual portion 237 (compare 137) protrudes out the left side 220 of the handle 210. The strap 230 may have a rubberized layer or coating 244 (compare 144) on its inner surface 236 (compare 136) to frictionally engage the jar lids or bodies. In FIG. 2B, the loop 235 is shown having a small diameter (“D”) to illustrate the versatility (wide range of adjustability) of the jar opener device 200, thus making it possible, for example, to use for removing a screw-on bottle cap (soda bottle, beer bottle and the like).

The residual portion 237 of the strap 230 may be pulled or pushed through the tunnel 226 to reduce (shrink) or increase (enlarge) the length (or diameter) of the loop 235 to engage (grip) or disengage (release) itself from a jar lid or jar body. The strap 230 may be sufficiently stiff for pushing even the residual portion 237 of the strap 230 through the tunnel 226. The end portion 234 of the strap 230 wrapping around the post 252 may pivot freely (unrestrained) when the residual portion 237 is thusly manipulated, allowing the loop portion 235 of the strap to be tightened against either the jar lid or the jar itself.

### Methods of Using the Jar Opener

Some exemplary methods of using jar opener devices, such as those described hereinabove, for example the jar opener device 200, will now be described.

FIG. 3 shows a jar opener device 200 with its strap 230 encircling (engaging, gripping) a lid 310 of a jar 300 and the device's handle 210 extending outward from the lid 310. The lid 310 is shown seated (screwed onto) the mouth of the jar 300. FIG. 3A summarizes steps for an exemplary method of using the jar opener 200, which may proceed generally as follows.

(Step 1: Prepare Loop 235 to Fit onto Lid 310)

First, the user slides (pushes or pulls) the strap 230 through the tunnel 226 to adjust the diameter (“D”) of the loop 235 (135) to be greater than the size (diameter) of the jar lid 310.

(Step 2: Orient the Device 200, and Cinch Strap 230 around Lid 310)

Then, the user orients the handle 210 with its top surface 216 facing up, with the residual portion 237 of the strap 230 extending to the left and the legend “LID” and/or an arrow being visible to the user. Then the user positions the strap 230 to surround the lid 310 of the jar 300. Then the user grasps the residual portion 237 of the strap 230 and pulls the strap 230 through the tunnel 226, thereby decreasing the circumference of the loop 235 so that the strap 230 securely engages (cinches around) the lid 310 of the jar 300.

(Step 3: Grasp Residual Strap 237 and Handle 210)

Then, the user grasps the handle 210 and the residual portion 237 of the strap 230 with one hand 360, so that the strap 230 is between the user's fingers 360 and the handle 210 with the residual portion 237 against the left side 220 of the handle 210. This helps “lock” the strap 230 in place so that it will resist being pulled out of the tunnel 226 when the user applies a force (torque) to the handle 210 for unseating the lid 310.

FIG. 3 shows the lever surface 213 immediately before engaging the outer surface of the strap 230. It is generally desirable to limit the extent (dimension “w3”) of the lever surface 213 to be as small as possible, so that it exerts only a sufficient force on the strap 230 to keep the strap 230 from slipping out of the tunnel 226 when the handle 210 is cocked to the right (arrow 320) for example for engaging and unseating the lid 310 from the jar 300. And, optionally, one or more small pointy spikes or the like (not shown) may be incorporated on the lever surface 213 for the purpose of engaging the strap 230 when applying force (torque) to the lid (or body) of a container, further assisting in preventing the strap 230 from slipping out of the tunnel 226 in the handle 210, when in use.

The force exerted by the lever surface 213 will be transmitted, via the strap 230, radially to the lid 310 or body 302 of a container (such as jar 300). If the lever surface 213 were wider (larger dimension “w3”), the radial force on the lid (or body) of the container would be greater, and may even be sufficient to deform or rupture the lid (or body) of the container.

The strap 230 should be long enough (“L2”) that it can extend out of the tunnel 236 and lay against the left side 220 of the handle 210 and be grasped firmly against the handle 210. This, along with the lever surface 213 (if present) being urged against the outer surface 238 of the strap 230 when the handle 210 is rotated, prevents the strap 230 from being pulled out of the tunnel 236 when the jar opener device 200 is in use.

(Step 4: Apply Counter Clockwise Force to Handle 210, while Grasping Jar 300 with Other Hand)

Then, with his (her) other (free) hand (not shown), the user may grasp and stabilize the body 302 of the jar 300. Then while restraining the jar 300 from moving (turning), the user then urges (pulls) the handle 210 in a counter clockwise direction, as indicated in the drawing by the arrow 320, and which may be displayed on the top 216 of the handle 210, which will further tighten the strap 230 against the lid 310 of the jar 300, securely engaging the lid 310, resulting in substantially all of the force which is being applied by the user to the handle 210 being transferred to the lid 310, thereby turning the lid 310 in a counter clockwise direction, as indicated by the arrow 322, for unseating the lid 310 from the mouth of the jar 300. Also, for device embodiments that have the lever surface 213 the rotating force pinches the strap 230 between the lid 310 and the lever surface 213 to firmly lock the strap against slipping, and secondly as the handle is forced to tilt over the lever surface 213 there is a cam action that further cinches the strap.

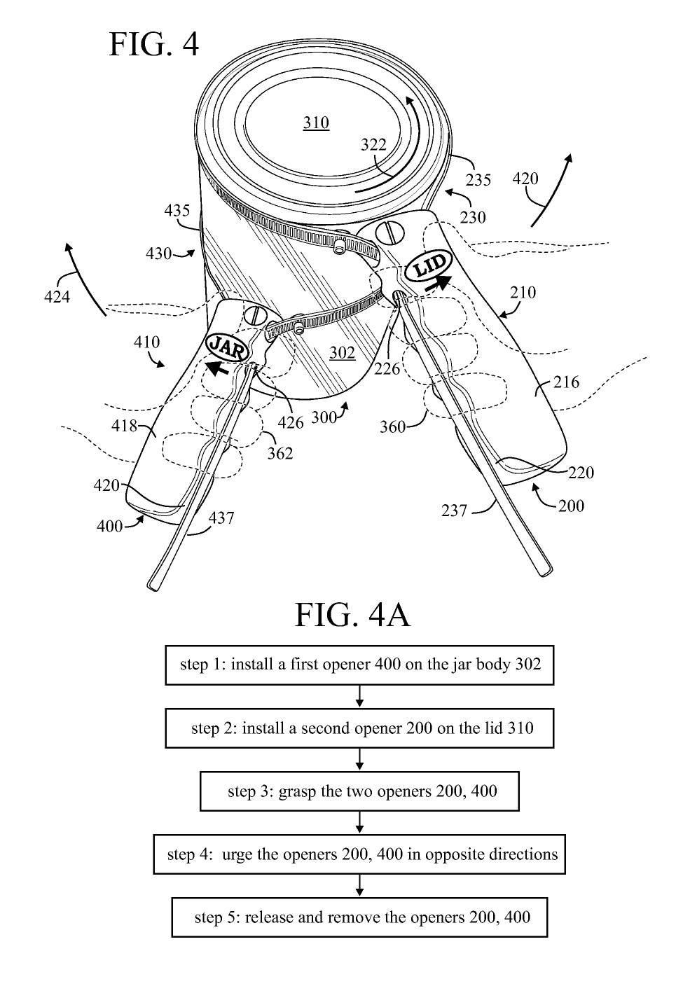

Alternatively, as described hereinbelow (FIG. 4), another jar opener device (400) may be used to apply force (torque) to the jar 300 for stabilizing it, including turning the jar body 302 in a direction opposite from the direction in which the lid 310 is turned.

(Step 5: Disengage Jar Opener Device 200 from Lid 310)

After the lid 310 is unseated, the user may continue to rotate the lid 310 for a few turns using the jar opener device 200 until the lid is removed from the jar 300, then disengage the strap 230 from the lid 310. Alternatively, after unseating the lid 310 from the jar 300, and before removing the lid 310 from the jar 300, the user may disengage the strap 230 from the lid 310 by pushing the residual portion 237 of the strap 230 into the tunnel 226 in the handle 210 until the loop 235 created by the strap 230 is enlarged enough to release the lid 310.

As shown in FIG. 3 (compare FIG. 1A) an insignia, indicia, arrow, marking or label or the like, here the word “LID” and an arrow may be disposed on the top surface 216 of the handle 210. This marking would be visible to the user when the jar opener device 200 is installed on the lid 310 of the jar 300 in a manner (orientation) suitable for unscrewing (unseating) the lid 310 from the mouth of the jar 300 by applying torque to the lid 310 in a counter-clockwise direction (as indicated by the arrow).

Although not specifically shown, if the user desires to use the jar opener device 200 to securely close (seat) the lid 310 on the mouth of the jar 300, the jar opener device 200 would be oriented “inverted” with top surface 216 and marking “LID” facing downward, rather than upward, with the bottom surface 218 and its associated marking (“JAR”) facing upwards, and torque would be applied to the lid 310 in a clockwise direction (as indicated by the arrow now showing on top with the marking “JAR”).

FIG. 4 shows a jar opener device 200 installed with its strap 230 encircling (engaging, gripping) the lid 310 for a jar 300 (same jar 300 as in FIG. 3) and its handle 210 extending outward from the lid 310. The lid 310 is shown seated (screwed onto) the mouth of the jar 300. FIG. 4 further shows another jar opener device 400 (compare 200) installed with its strap 430 (compare 230) encircling (engaging, gripping) the body 302 of the jar 300 and its handle 410 (compare 210) extending outward from the body 302 of the jar 300. The two jar openers 200 and 400 may be substantially identical with one another, but as will become evident, are used in opposite orientations from one another. Since the jar openers 200 and 400 may be substantially identical, some detail may be omitted from the description and drawing, for illustrative clarity. The two jar openers 200 and 400 constitute what may be referred to as a “jar opener system”.

FIG. 4A summarizes steps for an exemplary method of using the jar opener devices 200 and 400 to unseat (including unscrew) the lid 310 from the jar 300. The method may be referred to as a “two opener” or “dual opener” technique. One jar opener device 200 is used for grasping the lid 310, the other jar opener device 400 is used for grasping the body 302 of the jar 300. With the two jar openers operating in unison, an increased amount of torsional force may be applied for unseating (or seating) the lid. The method may proceed generally as follows.

(Step 1: Install a First Opener 400 on the Jar Body 302)

In a manner similar to that which was described hereinbefore (FIG. 3), the strap 430 (compare 230) of the jar opener device 400 is adjusted so that it can be installed, past the lid 310, onto the body 302 of the jar 300. Note that the jar opener device 400 is oriented “upside down”, with its bottom surface 418 (compare 218) facing up, its “left” (or “finger grip”) surface 420 (compare 220) to the right, with the residual portion 437 (compare 237) of the strap 430 extending out from the finger grip surface 420 to the right and the legend “JAR” with an arrow being visible. Then pull the strap 430 (compare 230) through the tunnel 426 (compare 226), thereby decreasing the circumference of the loop 435 (compare 235) so that the strap 430 securely engages (cinches) the body 302 of the jar 300. The jar opener device 400 will stay engaged to the jar body 302 by means of friction while the user has both hands free to prepare and position the jar opener device 200 on the lid 310 of the jar 300.

(Step 2: Install a Second Opener 200 on the Lid 310)

With the jar opener device 400 in place on the body 302 of the jar 300, the user can install the jar opener device 200 on the lid 310 of the jar 300, in the manner described hereinabove with respect to FIG. 3. The jar opener device 200 should also be able to stay mounted to the lid 310 without further assistance from the user (“hands free”), but this is not critical.

(Step 3: Grasp the Two Openers 200, 400)

Next, the user grasps the two residual strap portions 237 and 437 and handles 210 and 410, respectively, as follows. Grasp the handle 210 and the residual portion 237 of the strap 230 with one hand, so that the strap 230 is between the user's fingers 360 and the handle 210 with the residual portion 237 against the left (or finger grip) side 220 of the handle 210. Grasp the handle 410 and the residual portion 437 of the strap 430 with the other hand, so that the strap 430 is between the user's hand 362 and the handle 410 with the residual portion 437 held against the finger grip side 420 of the handle 410. Note that the hand 362 may either be oriented with the palm pushing against the finger grip side 420 of the handle 410, or the hand 362 may be inverted (palm up as illustrated) so that the user's fingers 362 are pulling on the finger grip side 420 of the handle 410.

(Step 4: Urge the Openers 200, 400 in Opposite Directions)

Then, for unseating the lid 302, the user applies force to (urges) both of the jar opener devices 200 and 400 as follows. The user urges the jar opener device 400 on the body 302 of the jar 300 in the clockwise direction illustrated by the arrow 424 in the drawing, and as indicated by the arrow which may be displayed along with the symbol “JAR” on the upper side 418 of the inverted handle 410. Simultaneously, the user urges the jar opener device 200 on the lid 302 of the jar 300 in an opposite, counter-clockwise direction, as illustrated by the arrow 420 (compare 320), and as indicated by the arrow which may be displayed along with the symbol “LID” on the upper side (top surface) 216 of the handle 210. This will further tighten both straps 430 and 230 against the jar body 302 and the lid 310, respectively, and will result in the lid 302 turning in the counter-clockwise direction, as indicated by the arrow 322. Continue, as desired, until the lid 310 is removed from the jar 300.

(Step 5: Release and Remove the Openers 200, 400)

Then, in a final step, disengage the straps 230 and 430 of the jar opener devices 200 and 400, respectively, by pushing the residual portions 237 and 437 of the straps 230 and 430 into their respective handles 210 and 410, and remove the jar opener devices 200 and 400.

When used in pairs (FIG. 4), the jar opener devices of the present invention provide gripping and torsional force that will not require the user to be physically touching the jar body or lid, wherein the user will more easily be able to provide more torsional force than with other previous jar opener devices.

In another method (not shown), using only one jar opener device (such as 200), the jar opener device may be installed on the jar body (in the manner of 400) and used to stabilize the jar body (or apply reverse torque thereto) while the user uses his (her) hand either directly or indirectly (e.g., using another device such as the “cap snaffler”) to unscrew the lid from the mouth of the jar (or, in another example, to remove a screw cap from a bottle).

Although the invention has been illustrated and described in detail in the drawings and foregoing description, the same is to be considered as illustrative and not restrictive in character—it being understood that the embodiments shown and described have been selected as representative examples including presently preferred embodiments plus others indicative of the nature of changes and modifications that come within the spirit of the invention(s) being disclosed and within the scope of invention(s) as claimed in this and any other applications that incorporate relevant portions of the present disclosure for support of those claims. Undoubtedly, other “variations” based on the teachings set forth herein will occur to one having ordinary skill in the art to which the present invention most nearly pertains, and such variations are intended to be within the scope of the present disclosure and of any claims to invention supported by said disclosure.

What is claimed is:

1. A handheld jar opener device for turning a lid of a container, the device comprising:
a handle extending longitudinally from a front end to a back end, and laterally thereof having a top surface, a bottom surface, a left side and a right side;
a tunnel extending through the handle from an entrance near a corner of the front end and the right side, diagonally backward to the left side of the handle; and
a strap secured at one end to the handle near a corner of the front end and the left side, forming a loop frontward of the front end, and extending back through the tunnel.

2. The handheld jar opener device of claim 1, wherein:
the tunnel is sized and shaped such that the strap fits snugly in the tunnel.

3. The handheld jar opener device of claim 1, further comprising:
a strap length sufficient to form the loop around the container and to extend a residual portion of the strap out of the tunnel and back-ward along the left side of the handle.

4. The handheld jar opener device of claim 1, further comprising:
a laterally extending lever surface on the front end of the handle, disposed between the tunnel entrance and the right side of the handle.

5. The handheld jar opener device of claim 1, wherein:
the strap extends from an opening near a corner of the front end and the left side of the handle: and
the tunnel extends to a position on the left side of the handle which is longitudinally displaced from the opening towards the back end of the handle.

6. The handheld jar opener device of claim 1, further comprising:
a strap inner surface provided with a non-slip layer for frictionally engaging the lid of the container.

7. The handheld jar opener device of claim 1, wherein:
the tunnel extends diagonally from the right side of the handle to the left side of the handle.

8. The handheld jar opener device of claim 1, wherein:
the tunnel extends diagonally back-ward from the front end of the handle to the left side of the handle.

9. The handheld jar opener device of claim 1, wherein:
the jar opener device is sized and shaped to securely engage either the lid or a body of the container.

10. The handheld jar opener device of claim 9, wherein:
the container is selected from the group consisting of jar and bottle.

11. A jar opener system comprising:
a first handheld jar opener device formed according to claim 1 and adapted in use to securely engage the lid of the container; and
a second handheld jar opener device formed according to claim 1 and adapted in use to securely engage a body of the container.

12. The jar opener system of claim 11, wherein:
the first and second handheld jar opener devices are substantially identical to one another.

13. A method of removing a lid from a container, the method comprising the steps of:
providing a first jar opener device formed according to claim 1;
installing the first jar opener device with the loop of its strap encircling the lid of the container;
while restraining the container from rotating, grasping the handle and applying torque to the first jar opener device to at least unseat the lid.

14. The method of claim 13, further comprising the step of:
after the step of installing the first jar opener device, moving the strap back-ward through the tunnel to cinch the loop for securely engaging the lid of the container.

15. The method of claim 13, further comprising the steps of:
forming the tunnel entrance through the front end near the right side of the handle to provide a laterally extending lever surface on the front end of the handle, disposed between the tunnel entrance and the right side of the handle; and
applying torque in the direction from the left side toward the right side of the handle, such that the strap will be pinched between the lever surface and the lid, thereby restraining the strap from pulling out of the tunnel.

16. The method of claim 13, further comprising the step of:
when grasping the handle, securing a residual portion of the strap extending out of the tunnel against the handle to restrain the strap from pulling out of the tunnel.

17. The method of claim 13, further comprising the steps of:
providing a second jar opener device formed according to claim 1; and
installing the second jar opener device with the loop of its strap encircling the body of the container.

18. The method of claim 17, further comprising the step of:
installing the second jar opener device in an opposite orientation from the first jar opener device.

19. The method of claim 17, further comprising the steps of:
grasping the handle of the first jar opener device with one hand;
grasping the handle of the second jar opener device with another hand; and
applying torque in opposite rotational directions to the first and second jar opener devices.

20. The method of claim 19, further comprising the steps of:
providing each of the first and second jar opener devices with a tunnel that is sized and shaped such that the respective strap fits snugly in the respective tunnel of the respective first and second jar opener devices;
after the step of installing the first jar opener device, moving the strap back-ward through the tunnel to cinch the loop for securely engaging the lid of the container, then relying on the tunnel to hold the strap, keeping the first jar opener device in place without being hand held until the step of applying torque; and
after the step of installing the second jar opener device, moving the strap back-ward through the tunnel to cinch the loop for securely engaging the body of the container, then relying on the tunnel to hold the strap, keeping the second jar opener device in place without being hand held until the step of applying torque.
